(19) United States
(12) Patent Application Publication
(10) Pub. No.: US 2026/0329156 A1
(43) Pub. Date: Oct. 22, 2026

(54) REFLECTIVE MODULE AND CAMERA MODULE INCLUDING THE SAME

(71) Applicant: SAMSUNG ELECTRO-MECHANICS CO., LTD., Suwon-si (KR)

(72) Inventors: Min Jeong KANG, Suwon-si (KR); Young Hwan KWON, Suwon-si (KR)

(73) Assignee: SAMSUNG ELECTRO-MECHANICS CO., LTD., Suwon-si (KR)

(21) Appl. No.: 19/386,498

(22) Filed: Nov. 12, 2025

(30) Foreign Application Priority Data
Apr. 22, 2025 (KR) 10-2025-0052528

(51) Int. Cl. G03B 17/17; G02B 7/182

(52) U.S. Cl. CPC G03B 17/17; G02B 7/182

(57) ABSTRACT

A reflective module includes a reflective member including a reflective surface configured to change a propagation path of light from a first optical axis direction to a second optical axis direction; a reflective holder, on which the reflective member is mounted, being rotatable about a first rotational axis, parallel to the second optical axis direction, together with the reflective member, wherein rotation of the reflective holder about the first rotational axis is relative to a counterpart member; and a first hinge member, disposed between the reflective holder and the counterpart member, having at least a portion that is elastic to support the rotation of the reflective holder around the first rotational axis

### CROSS-REFERENCE TO RELATED APPLICATIONS

This application claims the benefit under 35 USC 119(a) of Korean Patent Application No. 10-2025-0052528 filed on Apr. 22, 2025, in the Korean Intellectual Property Office, the entire disclosure of which is incorporated herein by reference for all purposes.

### BACKGROUND

### 1. Field

The present disclosure relates to a camera module including a reflective member.

### 2. Description of the Background

Mobile devices may include a folded type camera module in which a reflective member is disposed in front of a lens to bend a propagation path of light. Since such a folded type camera module may extend the propagation path of light without increasing a thickness of the mobile device, thereby enabling high-magnification zoom functionality.

In such folded type camera modules, optical imaging stabilization can be achieved through two-axis rotation of the reflective member. For example, the reflective member may rotate around any two of a roll axis, a pitch axis, or a yaw axis.

The camera module may be equipped with a ball member that supports the rotation of the reflective member. The ball member may either move along a rotation direction or act as a rotational axis while rotating in place. However, because the ball member is typically positioned between adjacent components, there is a possibility of the ball member being detached due to various factors.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a reflective module includes a reflective member including a reflective surface configured to change a propagation path of light from a first optical axis direction to a second optical axis direction; a reflective holder, on which the reflective member is mounted, being rotatable about a first rotational axis, parallel to the second optical axis direction, together with the reflective member, wherein rotation of the reflective holder about the first rotational axis is relative to a counterpart member; and a first hinge member, disposed between the reflective holder and the counterpart member, having at least a portion that is elastic to support the rotation of the reflective holder around the first rotational axis.

The first hinge member may include a first hinge portion having an elongated contour extending in a direction parallel to the first rotational axis; a first base disposed on the reflective holder; and a second base disposed on the counterpart member, wherein the first hinge portion interconnects the first base and the second base.

In response to the reflective holder being rotated about the first rotational axis by at least a predetermined angle, the first base and the second base may come in contact with each other.

The first base may include a first protrusion extending toward the second base, and the second base comprises a second protrusion extending toward the first base at a position facing the first protrusion. In response to the reflective holder being rotated about the first rotational axis by at least a predetermined angle, the first protrusion of the first base and the second protrusion of the second base may come in contact with each other.

The reflective module may further include a first damper member disposed on one surface of the reflective holder facing the counterpart member; and a second damper member disposed on the counterpart member to face the first damper member, wherein, in response to the reflective holder being rotated about the first rotational axis by at least a predetermined angle, the first damper member and the second damper member come in contact with each other.

The reflective module may further include a rotation guide configured to support the reflective holder to rotate, together with the reflective member and the reflective holder, about a second rotational axis perpendicular to the first rotational axis, wherein the counterpart member is the rotation guide.

The reflective module may further include a housing accommodating the rotation guide, wherein rotation of the rotation guide about the second rotational axis is relative with respect to the housing.

The reflective module may further include a second hinge member disposed between the rotation guide and the housing, the second hinge member having at least a portion that is elastic to support rotation of the rotation guide about the second rotational axis.

The second hinge member may include a second hinge portion having an elongated contour extending in a direction parallel to the second rotational axis; a first base disposed on the rotation guide; and a second base disposed on the housing, wherein the second hinge portion interconnects the first base and the second base.

The reflective module may further include a ball member, disposed between the rotation guide and the housing, configured to support rotation of the rotation guide about the second rotational axis while rotating in place.

The housing may include a third damper member disposed on a bottom surface of the housing; and a fourth damper member disposed in a position spaced apart from the third damper member in the first rotational axis direction, with the second rotational axis interposed therebetween.

The third damper member may be disposed to face the reflective holder, and the fourth damper member may be disposed to face the rotation guide. In response to the rotation guide being rotated about the second rotational axis by at least a predetermined angle, the third damper member may come in contact with the reflective holder, and the fourth damper member may come in contact with the rotation guide.

The reflective module may further include a first lens module including one or more lenses disposed in the first optical axis direction, wherein the first lens module is coupled to the reflective holder, and rotates about the first rotational axis together with the reflective member and the reflective holder.

In another general aspect, a camera module includes a first lens module including one or more lenses disposed in a first optical axis direction; a second lens module including one or more lenses disposed in a second optical axis direction; and a reflective module, disposed between the first lens module and the second lens module, comprising a reflective member configured to change a propagation path of light from the first optical axis direction to the second optical axis direction. The first lens module and the reflective module are rotatable about a first rotational axis parallel to the second optical axis direction. The reflective module includes a first hinge member including a first hinge portion having an elongated contour extending in a direction parallel to the first rotational axis, the first hinge portion being configured to support rotation of the first lens module and the reflective module about the first rotational axis.

The first lens module and the reflective module may be rotatable about a second rotational axis perpendicular to both the first optical axis direction and the second optical axis direction. The reflective module may include a second hinge member including a second hinge portion having an elongated contour extending in a direction parallel to the second rotational axis, the second hinge portion being configured to support rotation of the first lens module and the reflective module about the second rotational axis.

The reflective module may include a reflective holder on which the reflective member is mounted and to which the first lens module is coupled; a rotation guide on which the reflective holder is supported; and a housing on which the rotation guide is supported, wherein the first hinge member is disposed between the reflective holder and the rotation guide, and the second hinge member is disposed between the rotation guide and the housing.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2A is a cross-sectional view of FIG. 1, taken along line I-I′.

FIG. 2B is a cross-sectional view of FIG. 1, taken along line II-II′.

FIG. 3 is a schematic exploded perspective view of the camera module of FIG. 1.

FIG. 4A is a plan view of a housing according to an embodiment of the present disclosure.

FIG. 4B is a side view of a housing according to an embodiment of the present disclosure.

FIG. 5 is a perspective view of a housing (to which a substrate is attached) according to an embodiment of the present disclosure.

FIG. 6 is an exploded perspective view of components related to a focus adjustment function of the camera module of FIG. 1.

FIGS. 7A and 7B illustrate a position of a second lens barrel during focus adjustment.

FIG. 8 illustrates a rotational axis during optical imaging stabilization of the camera module of FIG. 1.

FIG. 9 is an exploded perspective view of a reflective holder and a rotation guide.

FIG. 10 is a cross-sectional view illustrating a first rotational axis of a first lens barrel and a reflective member.

FIGS. 11A and 11B illustrate a first lens barrel and a reflective member rotating about a first rotational axis.

FIG. 12 illustrates an embodiment in which a damper is provided separately from a first hinge member.

FIG. 13 is an exploded perspective view of a rotation guide and a housing.

FIG. 14 is a cross-sectional view illustrating a second rotational axis of a first lens barrel and a reflective member.

FIGS. 15A and 15B illustrate a first lens barrel and a reflective member rotating about a second rotational axis.

FIG. 16 is an exploded perspective view of a reflective module according to another embodiment.

FIG. 17 is a cross-sectional view illustrating a first rotational axis of a first lens barrel and a reflective member.

FIGS. 18A and 18B illustrate a first lens barrel and a reflective member rotating about a first rotational axis.

FIG. 19 illustrates a modified example of a first hinge member.

FIG. 20 is a cross-sectional view illustrating a second rotational axis of a first lens barrel and a reflective member.

FIGS. 21A and 21B illustrate a first lens barrel and a reflective member rotating about a second rotational axis.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure relates to a camera module. The camera module of the present disclosure may be mounted on a portable electronic device such as a mobile communication terminal, a smartphone, a tablet PC, or the like.

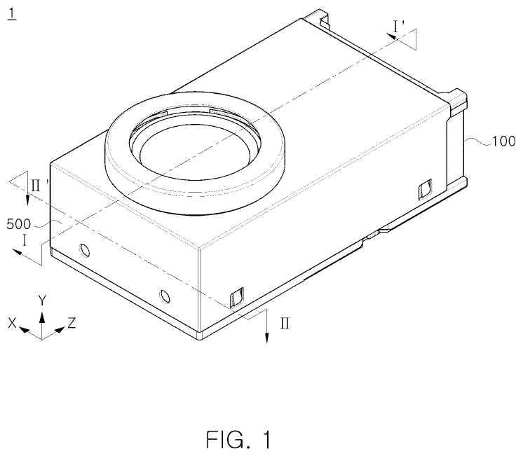

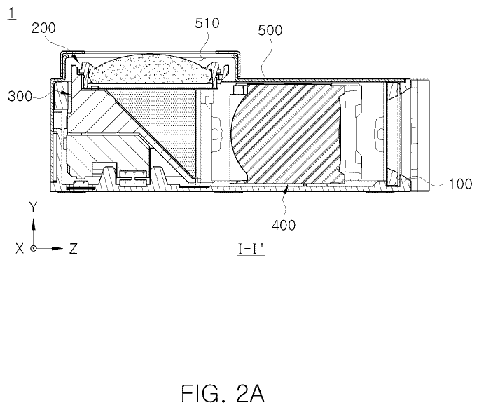

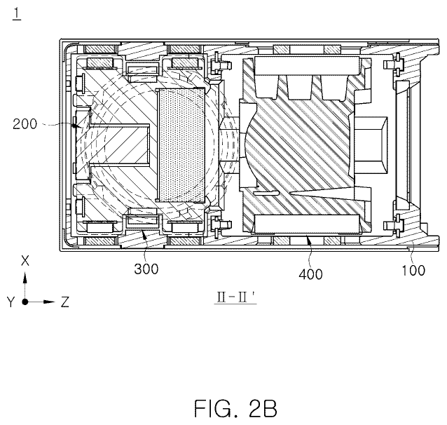

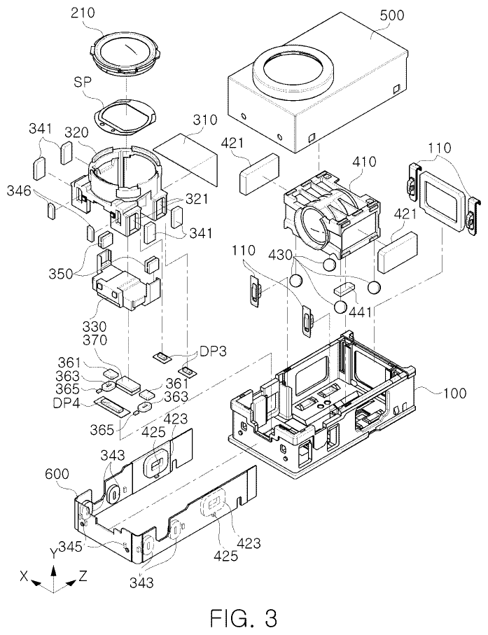

FIG. 1 is a perspective view of a camera module according to an embodiment of the present disclosure. FIG. 2A is a cross-sectional view of FIG. 1, taken along line I-I′. FIG. 2B is a cross-sectional view of FIG. 1, taken along line II-II′. FIG. 3 is a schematic exploded perspective view of the camera module of FIG. 1.

A camera module 1 may include a housing 100 and optical elements disposed in the housing 100. The optical elements may include a lens refracting light, and a reflective member reflecting light. The reflective member may be a prism. The lens and the reflective member may be provided in a form combined with other components. For example, the lens may be provided as a first lens module 200 and a second lens module 400, and the reflective member may be provided as a reflective module 300.

The reflective module 300 may be positioned between the first lens module 200 and the second lens module 400 to bend a path of light. For example, light passing through the first lens module 200 may be reflected by the reflective module 300 and incident on the second lens module 400. For example, an optical axis of the first lens module 200 and an optical axis of the second lens module 400 may be different from each other, and may be approximately perpendicular to each other.

Referring to FIGS. 2A and 2B, the first lens module 200 and the reflective module 300 may be disposed in a first optical axis direction (Y-axis direction). The first optical axis direction (Y-axis direction) may correspond to a height direction of the camera module 1. The first lens module 200 may be coupled to an upper side of the reflective module 300. Therefore, the first lens module 200 may move, together with the reflective module 300, when performing optical imaging stabilization. The reflective module 300 and the second lens module 400 may be disposed in a second optical axis direction (Z-axis direction). The second optical axis direction (Z-axis direction) may correspond to a length direction of the camera module 1. The second lens module 400 may be disposed to be spaced apart from the reflective module 300. The second lens module 400 may be configured to move when performing focus adjustment.

Although omitted in the drawings, the camera module 1 may further include an image sensor as an optical element disposed in the housing 100. Light incident on the camera module 1 may ultimately reach the image sensor, and may be converted into an electrical signal. The image sensor may be disposed in the housing 100 such that an imaging surface faces the second lens module 400.

The camera module 1 may include a shield can 500 coupled to the housing 100. Since the housing 100 has a box shape having an upper portion opened in an upward direction, the shield can 500 may be coupled to the housing 100 to cover the opened upper portion of the housing 100, thereby protecting the components. Additionally, the shield can 500 may shield electromagnetic waves.

The shield can 500 may include an opening 510 for allowing light to enter the camera module 1. The first lens module 200 may be disposed in the opening 510, and light may be entered into the first lens module 200.

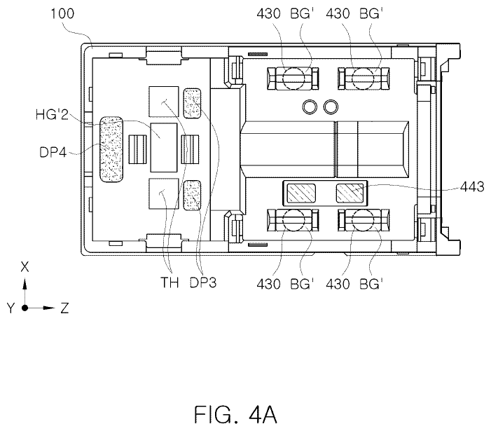

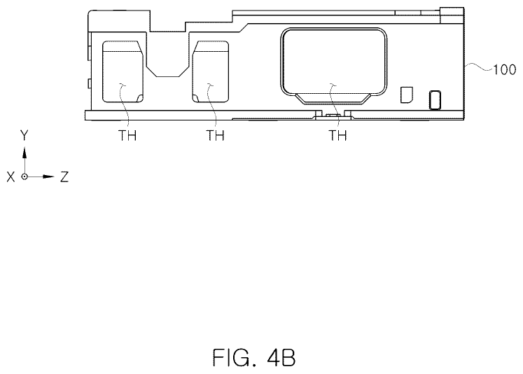

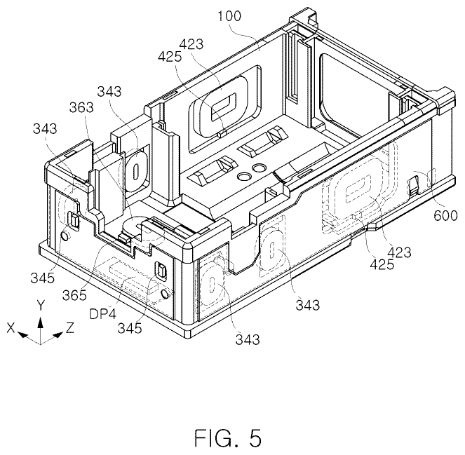

FIG. 4A is a plan view of a housing according to an embodiment of the present disclosure. FIG. 4B is a side view of a housing according to an embodiment of the present disclosure. FIG. 5 is a perspective view of a housing (to which a substrate is attached) according to an embodiment of the present disclosure.

Optical elements, as described above, may be disposed to be movable in a housing 100. For example, a hinge member may be disposed between a reflective module 300 and the housing 100, and a ball member may be disposed between a second lens module 400 and the housing 100. The hinge member and the ball member enable relative movement of the optical elements with respect to the housing 100.

Referring to FIG. 4A, the housing 100 may include an accommodation groove HG′2 in which the hinge member is assembled in a space in which the reflective module 300 is disposed. In addition, the housing 100 may include a ball guide groove BG′ in which the ball member is inserted in a space in which the second lens module 400 is disposed. The number of ball guide grooves BG′ may be provided in a number corresponding to the number of ball members disposed between the second lens module 400 and the housing 100.

Referring further to FIG. 4B, the housing 100 may include a through-hole TH in side and bottom surfaces. A driving unit for driving the reflective module 300 and the second lens module 400 may be disposed in the through-hole TH. For example, the driving unit may include a driving magnet and a driving coil disposed to face each other, and the driving magnet and the driving coil may face each other through the through-hole TH.

Referring to FIG. 5, a substrate 600 may be attached to an outer surface of a housing 100. For example, the substrate 600 may be formed of a flexible material for at least a portion thereof, and may be disposed over multiple surfaces of the housing 100.

A portion of a driving unit, as described above, may be mounted on the substrate 600. For example, a driving coil may be mounted on the substrate 600, for example, attached to the housing 100 via the substrate 600. In addition, a position sensor or the like may be also mounted on the substrate 600.

A camera module 1 has a focus adjustment function and an optical imaging stabilization function. As described above, the focus adjustment function may be implemented through a second lens module 400, and the optical imaging stabilization function may be implemented through a reflective module 300. When performing the optical imaging stabilization, a first lens module 200 coupled to the reflective module 300 may also move together.

First, components related to the focus adjustment function of the camera module 1 will be described.

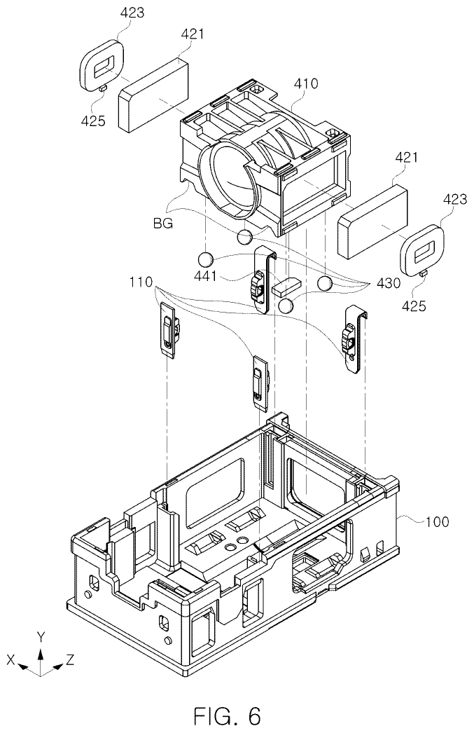

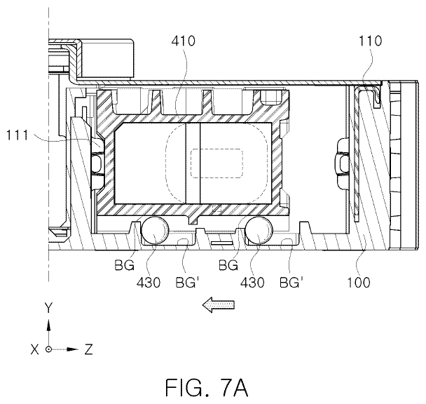

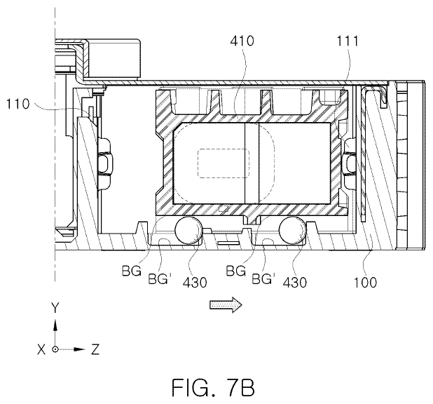

FIG. 6 is an exploded perspective view of components related to a focus adjustment function of the camera module of FIG. 1. FIGS. 7A and 7B illustrate a position of a second lens barrel during focus adjustment.

A second lens module 400 may include a second lens barrel 410 on which a plurality of lenses are mounted. The second lens barrel 410 may have the plurality of lenses mounted in the second optical axis direction (Z-axis direction).

The second lens barrel 410 may move relative to a housing 100 in the second optical axis direction (Z-axis direction).

The second lens module 400 may include a driving unit (hereinafter, AF driving unit) generating driving force to move the second lens barrel 410.

The AF driving unit may include an AF driving magnet 421 and an AF driving coil 423, disposed to face each other.

The AF driving unit may include at least one AF driving magnet 421 and at least one AF driving coil 423. The AF driving magnet 421 and the AF driving coil 423 may be provided in corresponding numbers.

The AF driving magnet 421 may be disposed on a side surface of the second lens barrel 410, and the AF driving coil 423 may be disposed in the housing 100 to face the AF driving magnet 421. The AF driving coil 423 may be disposed in a through-hole TH of the housing 100, in a state mounted on a substrate 600, to face the AF driving magnet 421.

The AF driving magnet 421 and the AF driving coil 423 may generate driving force in the second optical axis direction (Z-axis direction). The second lens barrel 410 may move along the second optical axis direction (Z-axis direction) by the driving force. When the second lens barrel 410 moves along the second optical axis direction (Z-axis direction), a distance between the plurality of lenses and the image sensor mounted on the second lens barrel 410 may be changed, thereby performing focus adjustment of a camera module 1.

The AF driving unit may further include a position sensor 425 sensing a position of the second lens barrel 410. The position sensor 425 may be disposed in the housing 100 in a state mounted on the substrate 600 together with the AF driving coil 423, and may face the AF driving magnet 421 through the through-hole TH. For example, the position sensor 425 may be a Hall sensor.

The AF driving coil 423 and the position sensor 425 may be fixedly disposed in the housing 100, while the AF driving magnet 421 may be disposed in the second lens barrel 410, and may thus move together with the second lens barrel 410. The position sensor 425 may sense a change in magnetic field formed by the AF driving magnet 421 to sense the position of the second lens barrel 410.

A plurality of ball members 430 may be disposed between the second lens barrel 410 and the housing 100 to assist the second lens barrel 410 move smoothly.

The plurality of ball members 430 may be provided in three or more. For example, the plurality of ball members 430 may be composed of four ball members (first to fourth ball members). The four ball members 430 may be divided into two each to support one side and the other side of the second lens barrel 410—the one side and the other side may be disposed opposite each other based on a second optical axis (Z-axis).

The plurality of ball members 430 may be inserted between ball guide grooves BG and BG′ formed in the second lens barrel 410 and the housing 100, respectively.

The plurality of ball members 430 may be individually accommodated in the ball guide grooves BG and BG′ to roll along the ball guide grooves BG and BG′. For example, the ball guide grooves BG and BG′ may have a length in the second optical axis direction (Z-axis direction), and the plurality of ball members 430 may roll in the second optical axis direction (Z-axis direction) in the ball guide grooves BG and BG′.

The second lens barrel 410 may be in close contact with the housing 100, with the plurality of ball members 430 interposed therebetween. For example, a pulling magnet 441 may be disposed in the second lens barrel 410, and a pulling yoke 443 may be disposed in the housing 100 to face the pulling magnet 441. The pulling magnet 441 and the pulling yoke 443 may generate attractive force in a direction facing each other, for example, in the first optical axis direction (Y-axis direction) of the drawing. By the attractive force, the second lens barrel 410 may be supported on the housing 100 in the first optical axis direction (Y-axis direction).

The pulling magnet 441 and the pulling yoke 443 may be disposed to be biased toward one side and the other side with respect to the second optical axis (Z-axis).

For example, when the pulling magnet 441 and the pulling yoke 443 are disposed to be biased toward one side with respect to the second optical axis (Z-axis), one side of the second lens barrel 410 may become a main guide. In contrast, when the pulling magnet 441 and the pulling yoke 443 are disposed to be offset to the other side with respect to the second optical axis (Z-axis), the other side of the second lens barrel 410 may become a main guide.

In this case, cross-sectional shapes of the ball guide grooves BG and BG′ provided on one side of the second lens barrel 410 and cross-sectional shapes of the ball guide grooves BG and BG′ provided on the other side of the second lens barrel 410 may be different from each other. Cross-sectional shapes of some of the ball guide grooves BG and BG′ may be different from remaining ones.

Referring to FIGS. 7A and 7B, a housing 100 may be provided with a stopper 110 restricting movement of a second lens barrel 410.

Stoppers 110 may be respectively provided on the front and rear sides of the second lens barrel 410. The second lens barrel 410 may collide with a stopper 110 provided on the front side of the second lens barrel 410 in a position moved to the maximum in a direction, away from an image sensor (−Z direction), and may collide with a stopper 110 provided on the rear side of the second lens barrel 410 in a position moved to the maximum in a direction, closer to the image sensor (+Z direction).

The stopper 110 may include a damper 111 absorbing shock and noise. The damper 111 may be provided in a protruding form toward the second lens barrel 410, and the second lens barrel 410 may collide with the damper 111.

Next, configurations related to the optical imaging stabilization function of the camera module 1 will be described.

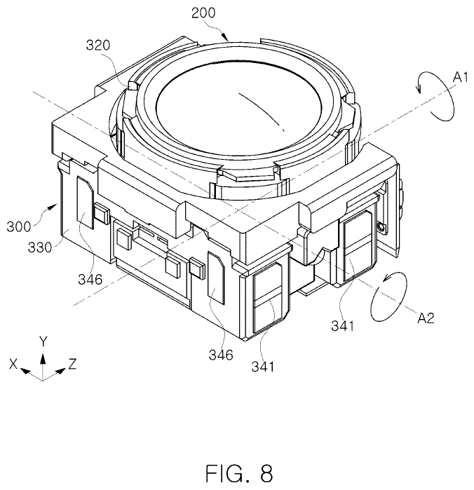

FIG. 8 illustrates a rotational axis during optical imaging stabilization of the camera module of FIG. 1.

The first lens module 200 and the reflective module 300 rotate about two rotation axes (hereinafter, first rotational axis A1 and second rotational axis A2) to perform optical imaging stabilization of the camera module 1.

The first rotational axis A1 and the second rotational axis A2 may be perpendicular to each other. For example, the first rotational axis A1 may be formed to be parallel to the second optical axis (Z-axis), and the second rotational axis A2 may be formed to be perpendicular to the first optical axis (Y-axis) and the second optical axis (Z-axis).

In the present specification, roll rotation or rolling means a rotational motion about the first rotational axis A1 of the first lens module 200 and the reflective module 300, and pitch rotation or pitching means a rotational motion about the second rotational axis A2 of the first lens module 200 and the reflective module 300.

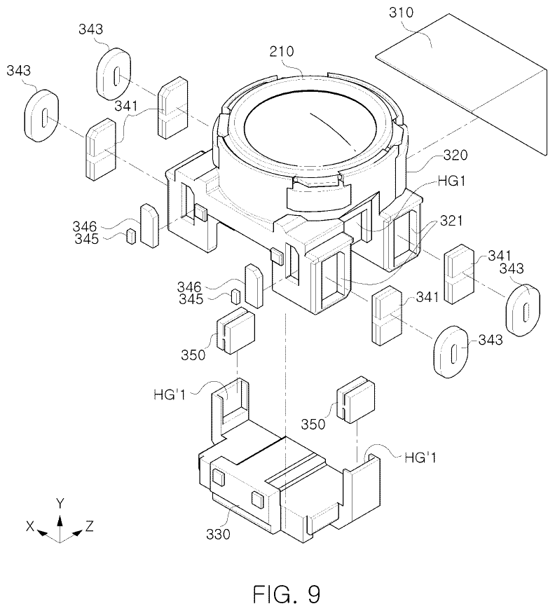

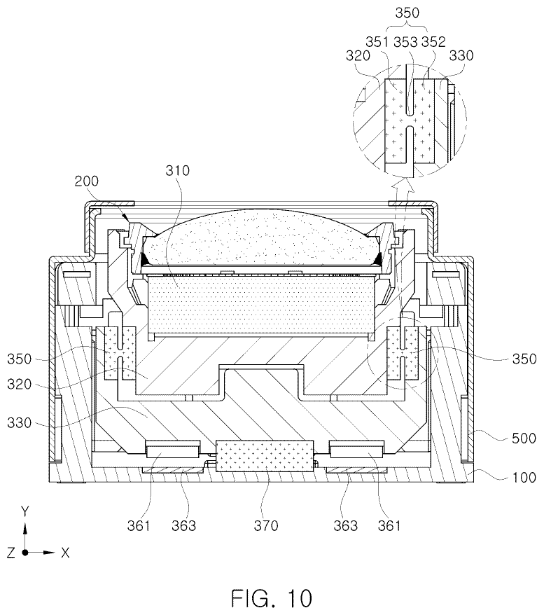

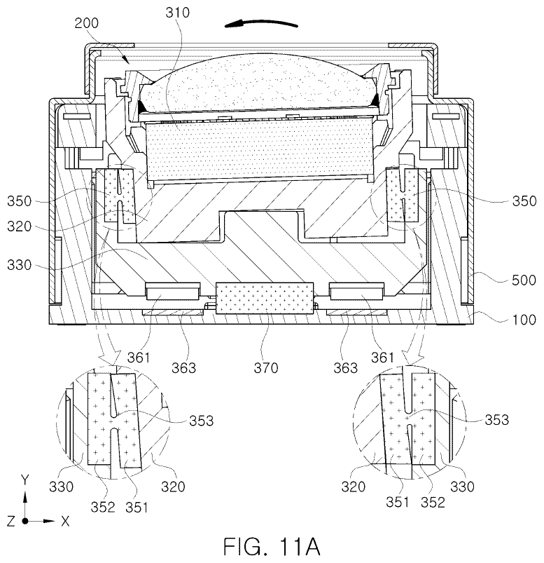

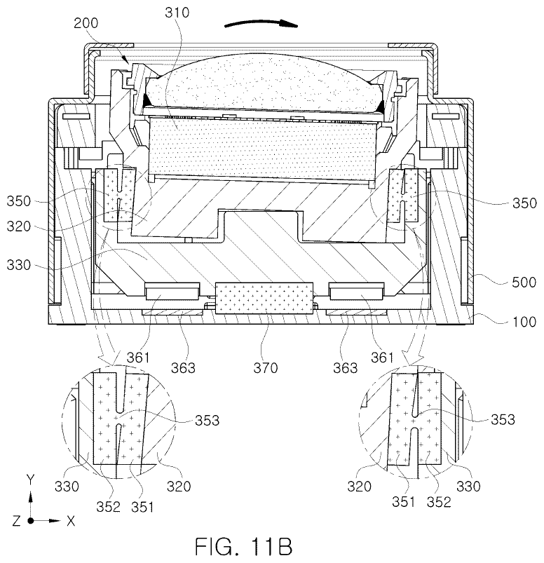

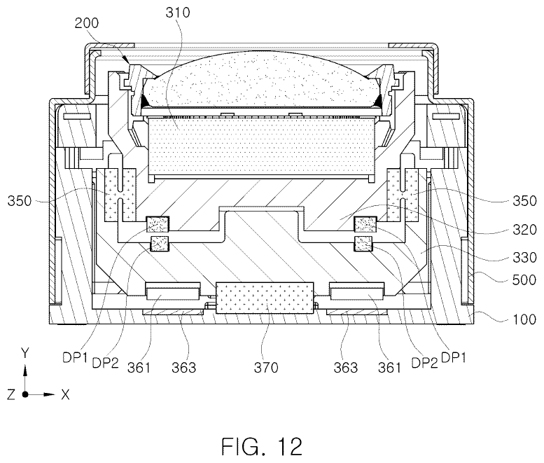

FIG. 9 is an exploded perspective view of a reflective holder and a rotation guide, FIG. 10 is a cross-sectional view illustrating a first rotational axis of a first lens barrel and a reflective member, FIGS. 11A and 11B illustrate a first lens barrel and a reflective member rotating about a first rotational axis, and FIG. 12 illustrates an embodiment in which a damper is provided separately from a first hinge member.

A first lens module 200 may include a first lens barrel 210 on which one or more lenses are mounted. The first lens barrel 210 may be equipped with the one or more lenses in the first optical axis direction (Y-axis direction).

The first lens barrel 210 may be equipped in a reflective module 300. For example, the first lens barrel 210 may be equipped in a reflective holder 320, together with a reflective member 310. Since the first lens barrel 210 and the reflective member 310 may be equipped together in the reflective holder 320, it may be easy to align optical axes. The first lens barrel 210 and the reflective member 310 may be disposed in the reflective holder 320 in the first optical axis direction (Y-axis direction).

A spacer SP may be disposed between the first lens barrel 210 and the reflective member 310. The spacer SP may also be equipped in the reflective holder 320. The spacer SP may have an incident hole through which light passes. Therefore, light may pass through the first lens module 200 to be incident on the reflective member 310.

A reflective module 300 may include the reflective member 310, the reflective holder 320, and a rotation guide 330.

The reflective member 310 may be disposed on the reflective holder 320. The reflective member 310 may be a member reflecting light, and may be provided as a prism having an incident surface, a reflective surface, and an emission surface.

The reflective member 310 may change an optical axis of incident light from a first optical axis (Y-axis) to a second optical axis (Z-axis). To this end, the incident surface of the reflective member 310 may be perpendicular to the first optical axis (Y-axis), the emission surface may be perpendicular to the second optical axis (Z-axis), and the reflective surface may be inclined at about 45 degrees with respect to the first optical axis (Y-axis) and the second optical axis (Z-axis).

The reflective holder 320 and the rotation guide 330 may move (rotate) relative to a housing 100. In detail, the reflective holder 320 may rotate relative to the rotation guide 330 and the housing 100, based on a first rotational axis A1, and the reflective holder 320 and the rotation guide 330 may rotate relative to the housing 100, based on a second rotational axis A2.

The reflective module 300 may include a driving unit (hereinafter, “OIS driving unit”) that generates driving force for rotating the reflective holder 320 and the rotation guide 330.

The OIS driving unit may include an OIS driving magnet 341 and an OIS driving coil 343, disposed to face each other. The OIS driving magnet 341 and the OIS driving coil 343 may provide driving force for rotating the reflective module 300 about the first rotational axis A1 and the second rotational axis A2.

The OIS driving magnet 341 may be disposed on the reflective holder 320. For example, the OIS driving magnet 341 may be disposed on a side surface of the reflective holder 320.

In addition, the OIS driving magnet 341 may include a plurality of magnets. For example, the OIS driving magnet 341 may include four magnets.

In an embodiment, the four magnets may be disposed in two on both sides of the reflective holder 320 spaced apart in the X-axis direction, based on the drawing, with the reflective member 310 interposed therebetween.

Protrusions 321 protruding in the X-axis direction based on the drawing may be provided on both sides of the reflective holder 320 at intervals from each other. For example, the protrusions 321 may be provided to be spaced apart in the second optical axis direction (Z-axis direction). The four magnets may be disposed on the protrusions 321.

The OIS driving magnet 341 may be magnetized such that a surface facing the OIS driving coil 343 has both an N pole and an S pole. For example, a surface of the OIS driving magnet 341 facing the OIS driving coil 343 may be provided with an N pole, a neutral region, and an S pole in sequence in the first optical axis direction (Y-axis direction).

The OIS driving coil 343 may be provided in a number corresponding to the OIS driving magnet 341. For example, the OIS driving coil 343 may include four coils, and the four coils may be provided to face four magnets in a one-to-one manner.

The OIS driving coil 343 may be mounted on a substrate 600, and may be disposed in the housing 100. The OIS driving coil 343 may be disposed in a through-hole TH of the housing 100, and may directly face the OIS driving magnet 341.

When power is applied to the OIS driving coil 343, the OIS driving magnet 341 and the OIS driving coil 343 may generate both driving force required for rotation about the first rotational axis A1 and driving force required for rotation about the second rotational axis A2.

For example, the OIS driving unit may rotate the reflective holder 320 and the rotation guide 330 by adjusting the driving force formed by the four magnets constituting the OIS driving magnet 341 and the four coils constituting the OIS driving coil 343. For example, directions of the driving forces formed by a pair of magnet and coil, diagonally spaced, may be opposite to each other.

The reflective module 300 may further include a position sensor 345 sensing a position of the reflective holder 320.

The position sensor 345 may be mounted on the substrate 600, together with the OIS driving coil 343, and may be disposed in the housing 100. The position sensor 345 and the OIS driving coil 343 may be mounted on the same surface of the substrate 600, and the position sensor 345 may also directly face the OIS driving magnet 341 through the through-hole TH.

The position sensor 345 may sense a change in magnetic field generated by the OIS driving magnet 341, to sense the position of the reflective holder 320. For example, the position sensor 345 may be a Hall sensor.

The OIS driving coil 343 and the position sensor 345 may be fixedly disposed on the housing 100, while the OIS driving magnet 341 may be disposed on the reflective holder 320, and may thus rotate together with the reflective holder 320. Therefore, the position sensor 345 may sense the change in magnetic field formed by the OIS driving magnet 341, to sense the position of the reflective holder 320.

In another embodiment, the position sensor 345 and the OIS drive coil 343 may be mounted on different surfaces of the substrate 600. In this case, a sensing magnet 346 may be disposed on the reflective holder 320 to face the position sensor 345.

Referring to FIG. 9 or the like, a sensing magnet 346 may be disposed on a back surface of a reflective holder 320—a surface connecting both side surfaces of the reflective holder 320. The sensing magnet 346 may be provided in one or more. When the sensing magnet 346 is provided in two, the two sensing magnets 346 may be spaced apart in the X-axis direction, based on the drawing, with a first rotational axis A1 interposed therebetween. The position sensor 345 may also be provided in two to face the sensing magnets 346 respectively.

The position sensor 345 may be fixedly disposed in the housing 100, while the sensing magnet 346 may rotate together with the reflective holder 320, such that the position sensor 345 may sense a change in magnetic field formed by the sensing magnet 346 to sense a position of the reflective holder 320.

A hinge member (hereinafter, a first hinge member) 350 supporting rotation of the reflective holder 320 may be disposed between the reflective holder 320 and a rotation guide 330.

The first hinge member 350 may be provided with a rigid and elastic material to support the rotation of the reflective holder 320. Therefore, the first hinge member 350 may be deformed or bent for at least a portion.

The reflective holder 320 and the rotation guide 330 may be spaced apart by the first hinge member 350. Therefore, the reflective holder 320 may rotate relative to the rotation guide 330.

In an embodiment, the first hinge member 350 may include two hinge members spaced apart in the X-axis direction, based on the drawing, with the reflective member 310 therebetween.

In an embodiment, the first hinge member 350 may be disposed between the OIS driving magnets 341. On both sides of the reflective holder 320, the OIS driving magnets 341 may be spaced apart in the second optical axis direction (Z-axis direction), and the first hinge member 350 may be disposed between the OIS driving magnets 341.

The first hinge member 350 may include a first base 351 disposed on the reflective holder 320, a second base 352 disposed on the rotation guide 330, and a hinge portion (or hinge axis) 353 connecting the first base 351 and the second base 352.

The first base 351 and the second base 352 may be fixed to the reflective holder 320 and the rotation guide 330, respectively, through an adhesive or the like.

The reflective holder 320 and the rotation guide 330 may be provided with accommodation grooves HG1 and HG′1 into which the first base 351 and the second base 352 are assembled, respectively. An accommodation groove HG1 of the reflective holder 320 and an accommodation groove HG′1 of the rotation guide 330 may be provided to face each other.

The accommodation groove HG1 of the reflective holder 320 and the accommodation groove HG′1 of the rotation guide 330 may be provided to face each other between protrusions 321. Therefore, a portion of the rotation guide 330 may be located between the protrusions 321.

An adhesive may be applied to the accommodation grooves HG1 and HG′1, and the first base 351 and the second base 352 may be fixed to the accommodation grooves HG1 and HG′1 through the adhesive.

The first base 351 and the second base 352 may be disposed to face each other in the X-axis direction, based on the drawing, with a hinge portion 353 therebetween.

The hinge portion 353 may have an elongated contour extending in a direction parallel to a first rotational axis A1, which may be a rotational axis of the reflective holder 320, between the first base 351 and the second base 352, and may be provided in one or more.

The hinge portion 353 may be formed to have a relatively thinner thickness than that of the first base 351 and the second base 352, thereby providing elasticity.

The reflective holder 320 may be rotatable about the first rotational axis A1 at a predetermined angle by flexing the hinge portion 353. In this case, the first base 351 may rotate together with the reflective holder 320. For example, the first base 351 may rotate relative to the second base 352 through the hinge portion 353.

When the reflective holder 320 rotates about the first rotational axis A1, a gap between the first base 351 and the second base 352 may vary.

For example, when the reflective holder 320 rotates clockwise (hereinafter, first direction) with respect to the drawing, the first base 351 may move closer to the second base 352 at a lower end portion of a left hinge member and an upper end portion of a right hinge member, while moving farther from the second base 352 at an upper end portion of the left hinge member and a lower end portion of the right hinge member (see FIG. 11A). Conversely, when the reflective holder 320 rotates counterclockwise (hereinafter, second direction) with respect to the drawing, the first base 351 may move closer to the second base 352 at the upper end portion of the left hinge member and the lower end portion of the right hinge member, while moving farther away from the second base 352 at the lower end portion of the left hinge member and the upper end portion of the right hinge member (see FIG. 11B).

When the reflective holder 320 rotates to a maximum angle in either the first direction or the second direction about the first rotational axis A1, the first base 351 and the second base 352 may come in contact with each other, thereby limiting the rotation range of the reflective holder 320. In this case, the first hinge member 350 may function as a stopper. In addition, the first hinge member 350 may be formed of an elastic material, and may thus function as a damper absorbing shock and noise.

The description of the first hinge member 350, described above, may also be applied to other hinge members described below, and may be applied as is or modified as appropriate for each embodiment.

Referring to FIG. 12, damper members DP1 and DP2, separately from a first hinge member 350, may be additionally provided. The damper members DP1 and DP2 may be formed of an elastic material, and may serve as stoppers limiting a rotation range of a reflective holder 320 while alleviating shock or the like.

The damper members DP1 and DP2 may be disposed on a bottom surface of the reflective holder 320 and on one surface of a rotation guide 330 facing the bottom surface of the reflective holder 320 in the first optical axis direction (Y-axis direction). When the reflective holder 320 rotates about the first rotational axis A1, as illustrated in FIGS. 11A and 11B, the damper members DP1 and DP2 may be in contact with each other. For example, when the reflective holder 320 rotates, the damper members DP1 and DP2 may be in contact first, and then a first base 351 and a second base 352 of the first hinge member 350 may be in contact.

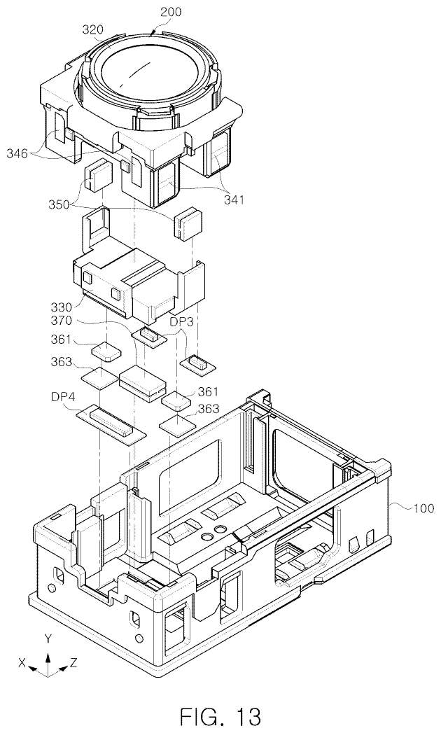

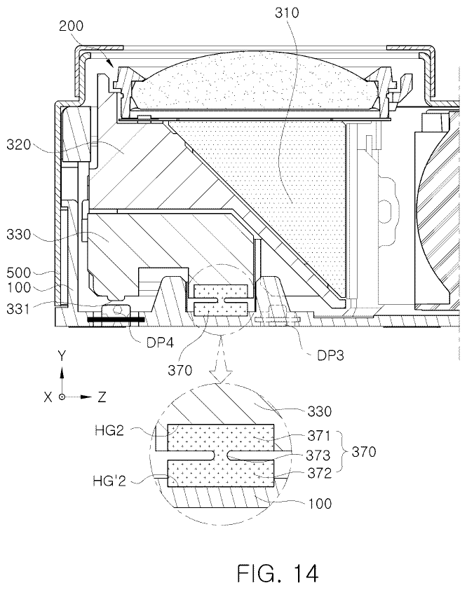

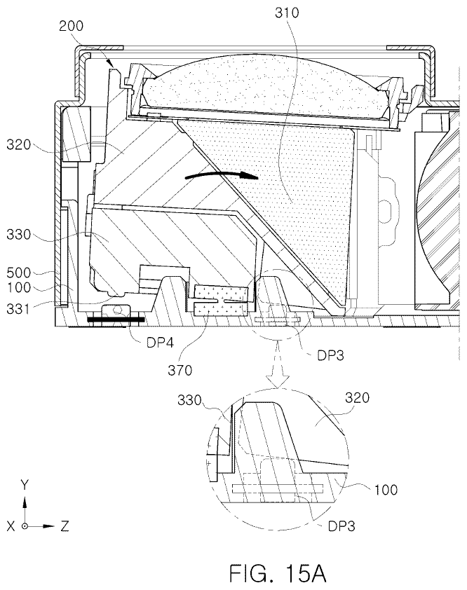

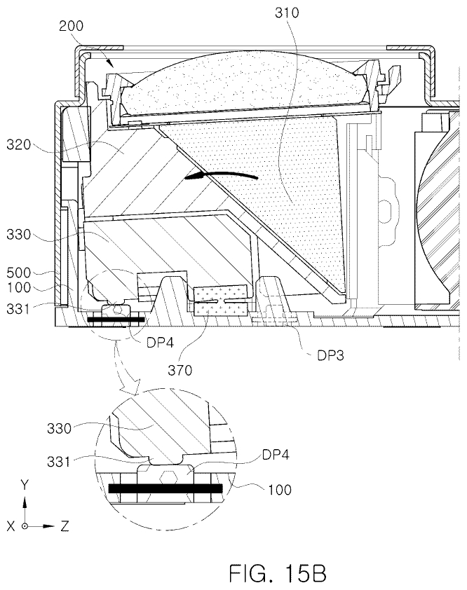

FIG. 13 is an exploded perspective view of a rotation guide and a housing, FIG. 14 is a cross-sectional view illustrating a second rotational axis of a first lens barrel and a reflective member, and FIGS. 15A and 15B illustrate a first lens barrel and a reflective member rotating about a second rotational axis.

As described above, a rotation guide 330 may rotate relative to a housing 100 based on a second rotational axis A2.

Between the rotation guide 330 and the housing 100, a hinge member (hereinafter, second hinge member) 370 supporting rotation of the rotation guide 330 may be disposed.

The second hinge member 370 may be provided with a rigid and elastic material to support the rotation of the rotation guide 330. Therefore, the second hinge member 370 may be deformed or bent in at least a portion thereof.

The rotation guide 330 and the housing 100 may be spaced apart by the second hinge member 370. Therefore, the rotation guide 330 may rotate relative to the housing 100.

In an embodiment, the second hinge member 370 may be provided in one, and a center of the second hinge member 370 may be approximately located on a second optical axis (Z-axis).

In an embodiment, the center of the second hinge member 370 may be approximately located on the second optical axis (Z-axis), and a pair of magnetic members 361 and 363 may be disposed on both sides of the second hinge member 370. For example, the pair of magnetic members 361 and 363 may be a pulling magnet 361 disposed on the rotation guide 330, and a pulling yoke 363 disposed on the housing 100. The pulling yoke 363 may be provided by being inserted into the housing 100.

The pair of magnetic members 361 and 363 may be configured to generate a magnetic attractive force in a direction facing each other. For example, the magnetic members 361 and 363 may face each other in the first optical axis direction (Y-axis direction) and generate attractive force in the first optical axis direction (Y-axis direction).

The rotation guide 330 may be supported on the housing 100 by the magnetic attractive force generated by the magnetic members 361 and 363.

The second hinge member 370 may include a first base 371 disposed on the rotation guide 330, a second base 372 disposed on the housing 100, and a hinge portion (or hinge axis) 373 connecting the first base 371 and the second base 372.

The first base 371 and the second base 372 may be fixed to the rotation guide 330 and the housing 100 respectively through an adhesive or the like.

The rotation guide 330 and the housing 100 may be provided with accommodation grooves HG2 and HG′2 into which the first base 371 and the second base 372 are inserted, respectively. An accommodation groove HG2 of the rotation guide 330 and an accommodation groove HG′2 of the housing 100 may be provided to face each other.

An adhesive may be applied to the accommodation grooves HG2 and HG′2, and the first base 371 and the second base 372 may be fixed to the accommodation grooves HG2 and HG′2 through the adhesive.

The first base 371 and the second base 372 may be disposed to face each other in the Y-axis direction, based on the drawing, with the hinge portion 373 therebetween.

The hinge portion 373 may have an elongated contour extending in a direction parallel to the second rotational axis A2, which may be a rotational axis of the rotation guide 330, between the first base 371 and the second base 372, and may be provided in one or more.

The hinge portion 373 may be formed to have a relatively thinner thickness than the first base 371 and the second base 372 to have elasticity.

The rotation guide 330 may rotate at a predetermined angle with respect to the second rotational axis A2 with respect to the hinge portion 373 as a center. In this case, the first base 371 may rotate together with the rotation guide 330. For example, the first base 371 may rotate with respect to the second base 352 with respect to the hinge portion 373.

When the rotation guide 330 rotates with respect to the second rotational axis A2, a gap between the first base 371 and the second base 372 may be changed.

For example, when the rotation guide 330 rotates in the first direction, the first base 371 may approach the second base 372 on a front side of the hinge member based on the hinge portion 373, and the first base 371 may move away from the second base 372 on a rear side of the hinge member (see FIG. 15A). Conversely, when the rotation guide 330 rotates in the second direction, the first base 371 may approach the second base 372 on the rear side of the hinge member based on the hinge axis 373, and the first base 371 may move away from the second base 372 on the front side of the hinge member (see FIG. 15B).

In a state in which the rotation guide 330 rotates about the second rotational axis A2 to the maximum in the first direction or the second direction, the first base 371 and the second base 372 may collide with each other. The second hinge member 370 may be formed of an elastic material, to act as a damper absorbing shock and noise, even when they collide with each other.

Referring to FIG. 13 or the like, damper members DP3 and DP4 may be provided in a housing 100, separately from a second hinge member 370. The damper members DP3 and DP4 may be provided in a form attached to a frame inserted into the housing 100. The damper members DP3 and DP4 may be provided of an elastic material, to act as a stopper limiting a rotation range of a rotation guide 330 while alleviating shock or the like.

The damper members DP3 and DP4 may be provided in a form protruding from a bottom surface of the housing 100 toward a reflective holder 320 or the rotation guide 330, and include a third damper member DP3 disposed on a front side of the second hinge member 370, and a fourth damper member DP4 disposed on a rear side of the second hinge member 370. Referring to FIG. 14, a third damper member DP3 may protrude toward a bottom surface of a reflective holder 320, and a fourth damper member DP4 may protrude toward a bottom surface of a rotation guide 330.

As illustrated in FIG. 15A, when a rotation guide 330 rotates in the first direction, a reflective holder 320 may be in contact with a third damper member DP3, and as illustrated in FIG. 15B, when a rotation guide 330 rotates in the second direction, the rotation guide 330 may be in contact with a fourth damper member DP4. A bottom surface of the rotation guide 330 may be provided with a protrusion 331 protruding toward the fourth damper member DP4, and the protrusion 331 of the rotation guide 330 may be in contact with the fourth damper member DP4.

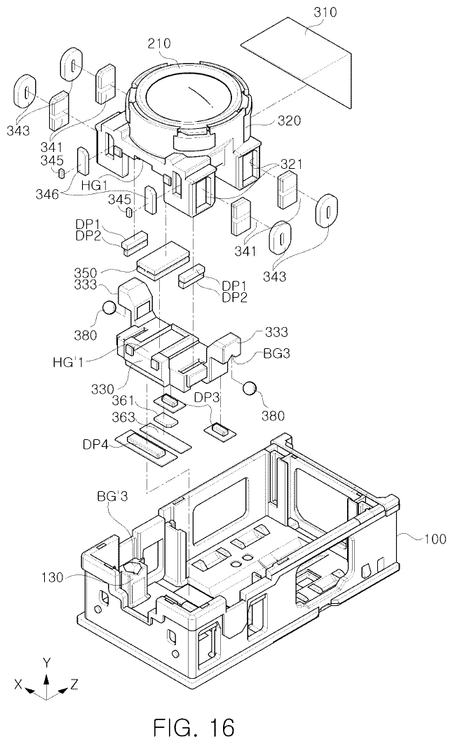

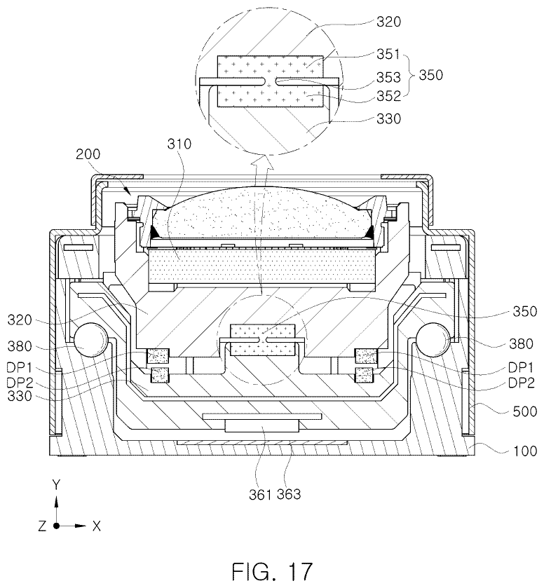

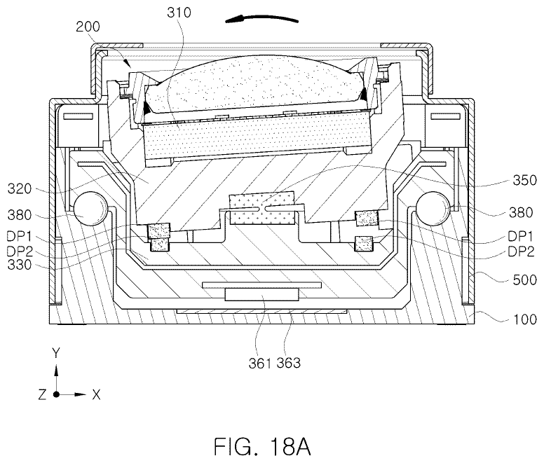

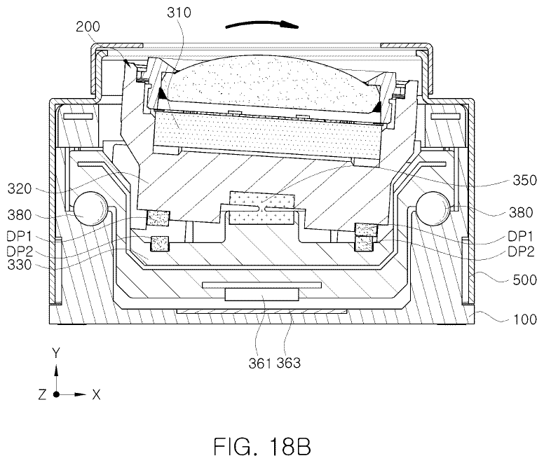

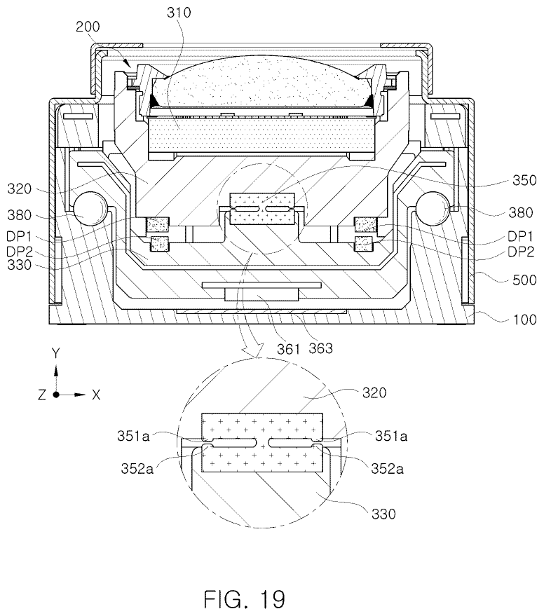

FIG. 16 is an exploded perspective view of a reflective module according to another embodiment, FIG. 17 is a cross-sectional view illustrating a first rotational axis of a first lens barrel and a reflective member, FIGS. 18A and 18B illustrate a first lens barrel and a reflective member rotating about a first rotational axis, and FIG. 19 illustrates a modified example of a first hinge member.

According to another embodiment of the present disclosure, a position of a first hinge member 350 disposed between a reflective holder 320 and a rotation guide 330 may be changed.

In an embodiment, the first hinge member 350 may be disposed on a bottom surface side of the reflective holder 320.

The first hinge member 350 may be provided in one, and a center of the first hinge member 350 may be approximately disposed on a first rotational axis A1.

A first base 351 of the first hinge member 350 may be assembled into an accommodation groove HG1 provided on a bottom surface of the reflective holder 320, and a second base 352 may be assembled into an accommodation groove HG′1 provided on one surface of the rotation guide 330 facing the bottom surface of the reflective holder 320. A hinge portion 353 may connect the first base 351 and the second base 352, and may have an elongated contour extending in a direction of the first rotational axis A1.

For example, when the reflective holder 320 rotates in the first direction, the first base 351 may approach the second base 352 on the right side with respect to the hinge portion 353, and the first base 351 may move away from the second base 352 on the left side (see FIG. 18A). Conversely, when the reflective holder 320 rotates in the second direction, the first base 351 may approach the second base 352 on the left side with respect to the hinge portion 353, and the first base 351 may move away from the second base 352 on the right side (see FIG. 18B).

As described above, the first hinge member 350 may have a damper function on its own.

Referring to FIG. 19, a first hinge member 350 may include protrusions 351a and 352a formed to protrude toward each other from a first base 351 and a second base 352.

The protrusions 351a and 352a may include a first protrusion 351a provided on the first base 351, and a second protrusion 352a provided on the second base 352 to face the first protrusion 351a.

The protrusions 351a and 352a may be provided on both sides based on a hinge portion 353. Preferably, the protrusions 351a and 352a may be provided in corner portions of the first base 351 and the second base 352.

The protrusions 351a and 352a may extend in a direction of a first rotational axis A1, like the hinge portion 353. The protrusions 351a and 352a may extend in a direction toward each other from the first base 351 and the second base 352, but may be configured not to be connected, to be spaced apart from each other, and to contact or move away from each other depending on a rotation direction of a reflective holder 320, like the hinge portion 353. When the reflective holder 320 rotates to the maximum, the protrusions 351a and 352a may perform functions of a stopper and a damper by first contacting each other.

As described above, damper members DP1 and DP2 may be disposed between the reflective holder 320 and a rotation guide 330, separately from the first hinge member 350.

The damper members DP1 and DP2 may be provided on both sides with respect to the first hinge member 350 (or with respect to the first rotational axis A1). The damper members DP1 and DP2 may be spaced apart in the X-axis direction with respect to the first hinge member 350 (or with respect to the first rotational axis A1).

The damper members DP1 and DP2 include a first damper member DP1 disposed on the reflective holder 320, and a second damper member DP2 disposed on the rotation guide 330. The first damper member DP1 may be disposed to be adjacent to a corner portion of a bottom surface of the reflective holder 320, and the second damper member DP2 may be disposed in the rotation guide 330 to face the first damper member DP1 in the first optical axis direction (Y-axis direction).

A gap formed between the first damper member DP1 and the second damper member DP2 in the first optical axis direction (Y-axis direction) may be equal to or narrower than a gap formed between the first base 351 and the second base 352 in the first optical axis direction (Y-axis direction). Therefore, when the reflector holder 320 rotates, the damper members DP1 and DP2 may be in contact first, and then the first base 351 and the second base 352 of the first hinge member 350 may be in contact.

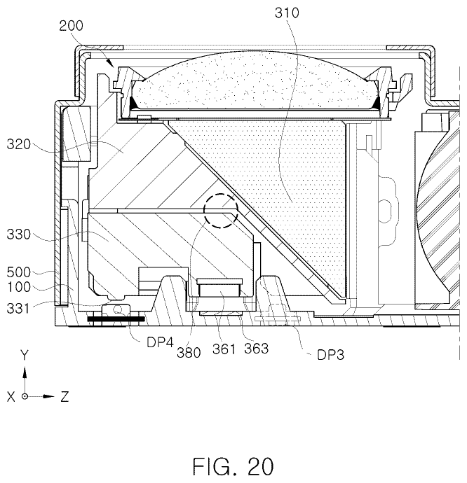

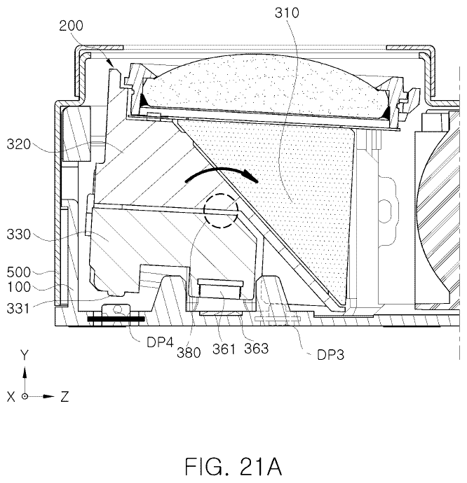

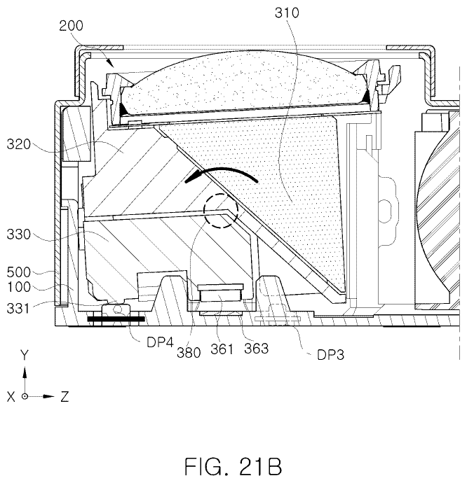

FIG. 20 is a cross-sectional view illustrating a second rotational axis of a first lens barrel and a reflective member, and FIGS. 21A and 21B illustrate a first lens barrel and a reflective member rotating about a second rotational axis.

According to another embodiment of the present disclosure, a ball member 380 may be disposed between a rotation guide 330 and a housing 100.

The ball member 380 may include a plurality of ball members 380, for example, two ball members, spaced apart from each other in a direction of a second rotational axis A2, and may form the second rotational axis A2. For example, the second rotational axis A2 may pass through the ball member 380. The rotation guide 330 may be supported by the ball member 380, and may rotate relative to the housing 100 about the second rotational axis A2.

The rotation guide 330 and the housing 100 may be each provided with accommodation grooves BG3 and BG′3 for accommodating the ball member 380. An accommodation groove BG3 of the rotation guide 330 and an accommodation groove BG′3 of the housing 100 may be provided to face each other, and the ball member 380 may be fitted between the accommodation grooves BG3 and BG′3.

In an embodiment, the rotation guide 330 may include an extension portion 333 extending in the X-axis direction in a body portion in which a reflector holder 320 or the like is mounted, and an accommodation groove BG3 of the rotation guide 330 may be provided in the extension portion 333. The housing 100 may include a protrusion wall 130 in a position corresponding to the extension portion 333 of the rotation guide 330, and an accommodation groove BG′3 of the housing 100 may be provided in the protrusion wall 130. The extension portion 333 of the rotation guide 330 may be supported by the protrusion wall 130 of the housing 100, with the ball member 380 therebetween.

The ball member 380 may be supported at three points in some of the accommodation grooves BG3 and BG′3, and the ball member 380 may rotate in place while a position thereof is fixed in the accommodation grooves BG3 and BG′3. The ball member 380 may be supported at two points in some of the remaining accommodation grooves BG3 and BG′3.

According to another embodiment of the present disclosure, the rotation guide 330 may be in close contact with the housing 100, with the ball member 380 therebetween. A pair of magnetic members 361 and 363 may be disposed to face each other on the rotation guide 330 and the housing 100. The pair of magnetic members 361 and 363 may generate attractive force in the first optical axis direction (Y-axis direction) facing each other, and the rotation guide 330 may be supported on the housing 100 by the attractive force. For example, the pair of magnetic members 361 and 363 may be a pulling magnet 361 disposed on the rotation guide 330, and a pulling yoke 363 disposed on the housing 100. The pulling yoke 363 may be inserted into and provided in the housing 100.

According to another embodiment, a first rotational axis A1 corresponding to a roll axis may be supported by a hinge member 350, and a second rotational axis A2 corresponding to a pitch axis may be supported by the ball member 380.

When the roll axis rotates, the reflective holder 320 may move along the first optical axis direction (Y-axis direction) with respect to the rotation guide 330. Therefore, when the ball member supports roll rotation, there may be a risk that the ball member may be detached, as a gap between accommodation grooves in which the ball member is accommodated widens. According to embodiments of the present disclosure, since roll axis rotation is supported by the first hinge member 350, detachment of the ball member may be prevented.

On the other hand, when the pitch axis rotates, the rotation guide 330 may move along the second optical axis direction (Z-axis direction) with respect to the housing 100. Therefore, when the ball member 380 supports rotation, possibility of the ball member 380 being detached may be low, as a gap between accommodation grooves in which the ball member 380 is accommodated does not widen significantly.

The present disclosure provides a camera module having improved driving stability during optical imaging stabilization.

According to one or more embodiments of the present disclosure, since there may be no concern about separation of a ball member, driving stability may be improved during optical imaging stabilization.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflective module comprising:
a reflective member comprising a reflective surface configured to change a propagation path of light from a first optical axis direction to a second optical axis direction;
a reflective holder, on which the reflective member is mounted, being rotatable about a first rotational axis, parallel to the second optical axis direction, together with the reflective member, wherein rotation of the reflective holder about the first rotational axis is relative to a counterpart member; and
a first hinge member, disposed between the reflective holder and the counterpart member, having at least a portion that is elastic to support the rotation of the reflective holder around the first rotational axis.

2. The reflective module of claim 1, wherein the first hinge member comprises:
a first hinge portion having an elongated contour extending in a direction parallel to the first rotational axis;
a first base disposed on the reflective holder; and
a second base disposed on the counterpart member,
wherein the first hinge portion interconnects the first base and the second base.

3. The reflective module of claim 2, wherein, in response to the reflective holder being rotated about the first rotational axis by at least a predetermined angle, the first base and the second base come in contact with each other.

4. The reflective module of claim 2, wherein the first base comprises a first protrusion extending toward the second base, and the second base comprises a second protrusion extending toward the first base at a position facing the first protrusion, and
wherein, in response to the reflective holder being rotated about the first rotational axis by at least a predetermined angle, the first protrusion of the first base and the second protrusion of the second base come in contact with each other.

5. The reflective module of claim 1, further comprising:
a first damper member disposed on one surface of the reflective holder facing the counterpart member; and
a second damper member disposed on the counterpart member to face the first damper member,
wherein, in response to the reflective holder being rotated about the first rotational axis by at least a predetermined angle, the first damper member and the second damper member come in contact with each other.

6. The reflective module of claim 1, further comprising a rotation guide configured to support the reflective holder to rotate, together with the reflective member and the reflective holder, about a second rotational axis perpendicular to the first rotational axis,
wherein the counterpart member is the rotation guide.

7. The reflective module of claim 6, further comprising a housing accommodating the rotation guide,
wherein rotation of the rotation guide about the second rotational axis is relative with respect to the housing.

8. The reflective module of claim 7, further comprising a second hinge member disposed between the rotation guide and the housing, the second hinge member having at least a portion that is elastic to support rotation of the rotation guide about the second rotational axis.

9. The reflective module of claim 8, wherein the second hinge member comprises:
a second hinge portion having an elongated contour extending in a direction parallel to the second rotational axis;
a first base disposed on the rotation guide; and
a second base disposed on the housing,
wherein the second hinge portion interconnects the first base and the second base.

10. The reflective module of claim 7, further comprising a ball member, disposed between the rotation guide and the housing, configured to support rotation of the rotation guide about the second rotational axis while rotating in place.

11. The reflective module of claim 7, wherein the housing comprises:
a third damper member disposed on a bottom surface of the housing; and
a fourth damper member disposed in a position spaced apart from the third damper member in the first rotational axis direction, with the second rotational axis interposed therebetween.

12. The reflective module of claim 11, wherein the third damper member is disposed to face the reflective holder, and the fourth damper member is disposed to face the rotation guide, and
in response to the rotation guide being rotated about the second rotational axis by at least a predetermined angle, the third damper member comes in contact with the reflective holder, and the fourth damper member comes in contact with the rotation guide.

13. The reflective module of claim 1, further comprising a first lens module comprising one or more lenses disposed in the first optical axis direction,
wherein the first lens module is coupled to the reflective holder, and rotates about the first rotational axis together with the reflective member and the reflective holder.

14. A camera module comprising:
a first lens module comprising one or more lenses disposed in a first optical axis direction;
a second lens module comprising one or more lenses disposed in a second optical axis direction; and
a reflective module, disposed between the first lens module and the second lens module, comprising a reflective member configured to change a propagation path of light from the first optical axis direction to the second optical axis direction,
wherein the first lens module and the reflective module are rotatable about a first rotational axis parallel to the second optical axis direction, and
wherein the reflective module comprises a first hinge member comprising a first hinge portion having an elongated contour extending in a direction parallel to the first rotational axis, the first hinge portion being configured to support rotation of the first lens module and the reflective module about the first rotational axis.

15. The camera module of claim 14, wherein the first lens module and the reflective module are rotatable about a second rotational axis perpendicular to both the first optical axis direction and the second optical axis direction, and
wherein the reflective module comprises a second hinge member comprising a second hinge portion having an elongated contour extending in a direction parallel to the second rotational axis, the second hinge portion being configured to support rotation of the first lens module and the reflective module about the second rotational axis.

16. The camera module of claim 15, wherein the reflective module comprises:
a reflective holder on which the reflective member is mounted and to which the first lens module is coupled;
a rotation guide on which the reflective holder is supported; and
a housing on which the rotation guide is supported,
wherein the first hinge member is disposed between the reflective holder and the rotation guide, and the second hinge member is disposed between the rotation guide and the housing.
